(19) United States
(12) Patent Application Publication
(10) Pub. No.: US 2014/0373738 A1
(43) Pub. Date: Dec. 25, 2014

(54) PLASTIC-BOTTLE COMPACTOR

(71) Applicant: Amir PUNDAK, Kiriyat Tivon (IL)

(72) Inventors: Or Henkin, Even Yehuda (IL); Didi Linn, Herzeliya (IL)

(73) Assignee: Amir PUNDAK, Kiriyat Tivon (IL)

(21) Appl. No.: 14/374,650

(22) PCT Filed: Jan. 24, 2013
(86) PCT No.: PCT/IL2013/050067

§ 371 Date: Jul. 25, 2014

Related U.S. Application Data
(60) Provisional application No. 61/590,451, filed on Jan. 25, 2012.

(51) Int. Cl. B29B 17/00; B30B 1/00

(52) U.S. Cl. CPC B29B 17/0052; B30B 1/00; B29B 2017/0063
USPC 100/230

(57) ABSTRACT

Provided is a bottle compactor including a housing configured with side walls and sized for receiving therein a bottle, an opening for axially introducing the bottle, a bottle-neck arresting plug configured for supporting a top end portion of the bottle, and a displacing mechanism configured for axially displacing said bottle-neck gripping plug along an axial guide member, between a bottle receiving position and a compacted position, and an opening cover for supporting the bottle as it is being compacted.

### FIELD OF THE DISCLOSURE

The present disclosed subject matter relates to a plastic-bottle compactor, namely a device configured for reducing the volume of a plastic-bottle, such as disposable beverage bottles, and the like.

### BACKGROUND AND PRIOR ART OF THE DISCLOSURE

Nowadays recycling of goods has become a major concern in most fields of life and in many authorities it is becoming now a requirement. However, one difficulty concerned with recycling of material is the volume such packages and containers consume during shipment and storage. In particular, but not restricted thereto, this is the case with domestic recycling and evermore so in case of plastic containers, in particular beverage containers which are commonly used. Such bottles are often made of plastic material which is not easily compacted and considerable force is required for deforming same into a compact size.

Thus, there is the need for a domestic or small scale operation device, suitable for easily compacting plastic-bottles, such as beverage bottles.

WO12120163 discloses a bottle compacter consisting of two platforms attached such that the surfaces thereof can come together while remaining parallel. The bottle is placed between said platforms, the neck fitting in the orifice made for that purpose in one of the platforms and the base of the bottle being supported on the other platform. Once the bottle has been compacted, it is possible to replace the bottle cap or to substitute another element to prevent air from entering and causing the bottle to return to the original shape.

US Patent Application Publication 2011283899 discloses a compactor device is provided including a cylindrical housing having an elongate channel for receiving a bottle to be compacted therein and elongate guide slots, an end cap attached to a first end of the housing for seating the bottle and protecting the neck end of the bottle, a piston slideably disposed within the channel and having a forward ram for stuffing the bottle, and a lever for actuating linear movement of the piston within the channel, whether manually or automated.

### SUMMARY OF THE INVENTION

According to the present disclosed subject matter there is provided a plastic-bottle compactor, configured for compacting the volume of a bottle from its initial, full-volume position, to a compacted, shrunk position.

The bottle compactor comprising a housing configured with side walls and sized for receiving therein a bottle, an opening for axially introducing the bottle, a bottle-neck arresting plug configured for supporting a top end portion of the bottle, and a displacing mechanism configured for axially displacing said bottle-neck gripping plug along an axial guide member, between a bottle receiving position and a compacted position.

The term bottle-neck refers to a top, open end of a bottle.

During compacting a bottle the neck arresting plug is axially displaced between an initial bottle loading position, towards the opening at a compacting position, and is displaced axially back to its initial position so as to receive an intact, uncompressed bottle.

Any one or more of the following features, designs and configurations can be applied in the subject of the presently disclosed subject matter, solely or in combinations thereof:
The opening of the housing is configured with a cover for supporting the bottle as it is being compressed/compacted;
The cover can be screw coupled to the housing. Screw coupling can be a regular thread or a thread configured with several starts and/or a thread having a substantially large pitch, to ease on screw-coupling the cover over the opening;
The cover can be coupled to the housing by a bayonet-type coupler;
The housing of the bottle compactor has a substantially tapering cross section;
Either or both the external shape and the inside shape of the housing can be configured with the general shape of a particular beverage bottle;
The opening of the housing can be configured at a bottom end thereof, wherein a top end of the housing can be non-openable;
The housing is configured with a bottle receiving space constituted by an inside surface of the sidewalls, wherein at least a bottom portion of said side walls can take part in determining the final shape of the compacted bottle;
The inside surface of the sidewalls can be substantially smooth;
The sidewalls of the housing can be configured with longitudinally extending openings. According to one particular design, the longitudinally extending openings are equally distributed about the housing;
The inside surface of the sidewalls can be configured with longitudinally extending sliding ribs, radially inwards oriented;
The bottle-neck arresting plug can be configured for insertion into a neck portion of a bottle, i.e. a bottle opening. The bottle-neck arresting plug can be cylindrical, or ribbed;
The bottle-neck arresting plug can have a tapering cross section or it can be configured with two or more diameters so as to comply with bottles having different diameter openings;
The bottle-neck arresting plug can be configured for screw coupling to a thread of the bottle-neck;
The bottle-neck arresting plug can be configured for bearing externally over the bottle-neck;
The bottle-neck arresting plug can be replaceable so as to be replaced depending on the diameter of the bottle opening;
The guide member extends through a major length of the bottle receiving space;
The displacing mechanism can be configured for single-hand manipulation;
The displacing mechanism can be configured with a force amplifying mechanism, such that it requires substantially little force for displacing the neck arresting plug between the bottle receiving position and the compacted position, also when a bottle is received at the bottle receiving space;
The force amplifying mechanism can be a gear train;
The force amplifying mechanism can be a leaver generating a moment over the displacing mechanism;
The force amplifying mechanism can be a worm type-screw mechanism;
The displacing mechanism can be configured with an electric motor to facilitate axial displacement of the neck arresting plug in one or both axial displacement directions, i.e. in a compacting direction towards the opening and back to its initial position. Displacement along the axial guide member can be facilitated by gear path along the axial guide member and a rider configured with cogged wheel travelling thereover, or a friction wheel traveling over a smooth or knurled axial guide member;
The displacing mechanism comprises an operating handle for manual manipulation of the displacing mechanism, said operating handle can radially project through a longitudinal opening formed along the housing;
The operating handle can be detached from the displacing mechanism;
The displacing mechanism can be removed from the housing;
The displacing mechanism can be configured with a reverse-locking mechanism to prevent unintended reverse axial displacement of the neck arresting plug during a bottle compacting process;
The displacing mechanism can be a mechanical ratchet-bar type mechanism;
The displacing mechanism can be a helical path configured over the axial guide member, with a worm rider mounted thereon, said rider articulated with the bottle-neck arresting plug;
The operating handle can be configured for adjusting a hand-grip size, for personalizing it to a hand size of different individuals;
The operating handle can be configured for arresting at a folded, compact position;
The operating handle can be biased into a released position thereof;
The compacted bottle is removed from the housing through the opening serving also for intruding the bottle;
The diameter of the compacted bottle corresponds with the inside diameter of a lower portion of the housing;
The bottle can be snugly received within the a bottle receiving space;
An adapting sleeve can be used for configuring the shape and size of the bottle receiving space, namely rendering it suitable for accommodating bottles of different diameters and bottles of non-cylindrical shapes;
The adapting ring can be configured for securing to the opening cover, or integrated therewith, for supporting bottles of different diameters and bottles of non-cylindrical shapes;
An adapting sleeve can extend substantially the entire length of the bottle receiving space, or at least at a bottom portion thereof;
Inside walls of the housing and of the adapting sleeve can be made of or applied with a friction-reducing agent;
The housing is made of a rigid material;
The diameter of the bottle receiving space can be configurable to accommodate bottles of different diameters, by applying the housing with one or more longitudinal recesses extending from the bottom opening and upwards, with the provision of a radius adapting mechanism configured for retaining the housing at any determined radial expansion state;
The radius adapting mechanism can be a fastener configured to assume any set position whereby the diameter of the bottom opening is retained and can bear any loads developing during a bottle compacting process. The radius adapting mechanism can be for example a ratchet mechanism or a screw fastener mechanism, or a thread fastener, etc.;
The axial guide member can be secured at a top end thereof within a top end of the housing;
The axial guide member can have any cross-section, e.g. rectangle, circular, oval, etc;
The axial guide member can be smooth or configured with patterns for improving displacement of the bottle-neck arresting plug thereover. For example, the axial guide member can be serrated, or knurled or configured with one or more helical paths, etc.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIG. 1A is a top isometric view of a bottle compactor according to an example of the present disclosed subject matter, holding an empty bottle at its fully expanded position;

FIG. 1B is a perspective exploded view of the bottle compactor of FIG. 1A;

FIG. 1C is the same as FIG. 1B, however with a different coupling arrangement of the openable cover to the housing;

FIG. 2A is a top view of FIG. 1;

FIG. 2B is a bottom view of FIG. 1;

FIG. 3A is a left side view of FIG. 1;

FIG. 3B is a right side view of FIG. 1;

FIG. 4 is a longitudinal section taken along line IV-IV in FIG. 1;

FIG. 5 corresponds with FIG. 1, with side walls of the housing removed for sake of visualizing;

FIG. 6 is an exploded isometric view of the bottle compactor with a bottle at its non-compacted position;

FIG. 7A is a top left side isometric view of a neck arresting plug displacing mechanism of the bottle compactor;

FIG. 7B is a bottom front side view of a neck arresting plug of the bottle compactor;

FIG. 8A is an isometric view, of a mechanical ratchet-bar type displacing 30 mechanism, one cover plate removed for visualizing components thereof;

FIG. 8B is an exploded isometric view of FIG. 8A;

FIG. 9 is a right side view of a neck arresting plug displacing mechanism according to a different example;

FIG. 10A is a top isometric view of a neck arresting plug according to an example of the bottle compactor;

FIG. 10B is a bottom isometric sectioned along line X-X in FIG. 10A;

FIG. 10C is a modification of the neck arresting plug;

FIG. 10D is a longitudinal section through an external neck arresting plug;

FIG. 10E is a longitudinal section through a different example of an external neck arresting plug;

FIG. 11A corresponds with FIG. 1, however at the compacted position;

FIG. 11B corresponds with FIG. 11A, however with a top portion of the housing removed for sake of visualizing;

FIG. 11C is a longitudinal section along line XI-XI in FIG. 11A;

FIG. 11D is a top view of FIG. 11A;

FIG. 12 is an isometric view of the compacted bottle removed from the device of FIGS. 11;

FIG. 13 is an isometric view of a bottle compactor according to a different example of the present disclosed subject matte;

FIG. 14A is an isometric view of a displacing mechanism according to another example;

FIG. 14B is the same as FIG. 14A, however with one cover shell removed for visualizing internal components;

FIG. 15A is an isometric view of a displacing mechanism according to yet another example;

FIG. 15B is the same as FIG. 15A, however with one cover shell removed for visualizing internal components;

FIGS. 16A and 16B are sectioned isometric views exemplifying a bottom cover configured with an adapting ring;

FIG. 17A is a top isometric view of a bottle compactor (the displacing mechanism removed), configured with an adjustable bottle receiving space, the housing at its reduced space configuration;

FIG. 17B is a bottom isometric view of the bottle compactor of FIG. 17A;

FIG. 17C is a longitudinal section taken along line XVII-XVII in FIG. 17A;

FIG. 17D is the same as FIG. 17A, the housing at an expanded bottle space configuration; and

FIG. 17E is a longitudinal section taken along line XVIII-XVIII in FIG. 17D;

### DETAILED DESCRIPTION OF EMBODIMENTS

Attention is directed to the drawings illustrating a bottle compacter in accordance with the disclosed subject matter, generally designated 20 which is a device configured for receiving a plastic container, such as, for example, a beverage drinking bottle 22 (though any other plastic containers are acceptable for that purpose) and compacting it into a minimal volume consuming piece of material for environmental considerations.

The device comprises a housing 24 of generally elongate shape, made of a rigid material such as metal or strong plastic material, extending along a longitudinal axis thereof designated X and has a cylindrical shape tapering upwards configured with side walls 26 equally distributed about the periphery of the housing and further configured with three longitudinally extending apertures 28. Each of the apertures 28 has at a bottom portion thereof an outwardly extending lip portion 32 the purpose of which will become apparent hereinafter.

A bottom portion of the housing 24 is configured with an openable cover 36 serving as a base of the device 20, through which the plastic container 22 is introduced and later removed.

Fitted within of device there is a displacing mechanism generally designated 40, to be discussed hereinafter with further detail. The displacing mechanism 40 is configured for axially displacement of a bottle-neck arresting plug 44 slideably displaceable about an axial guiding member 46 which in the present example is a flat rod of material (metal, reinforced plastic material, etc.) extending within the housing 24 and being integrated at its top end to the displacing mechanism 40.

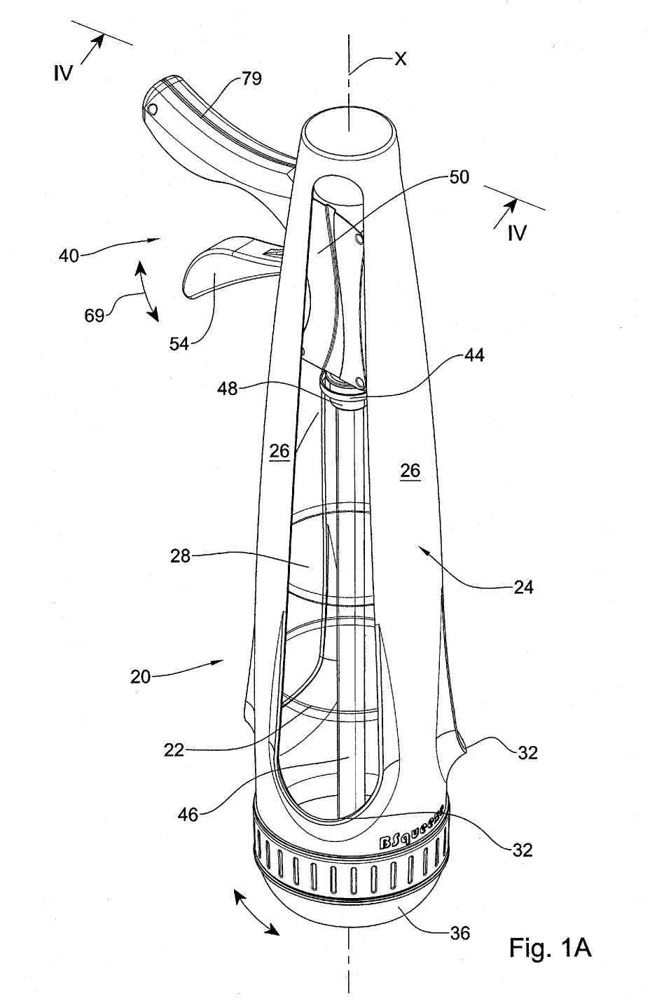

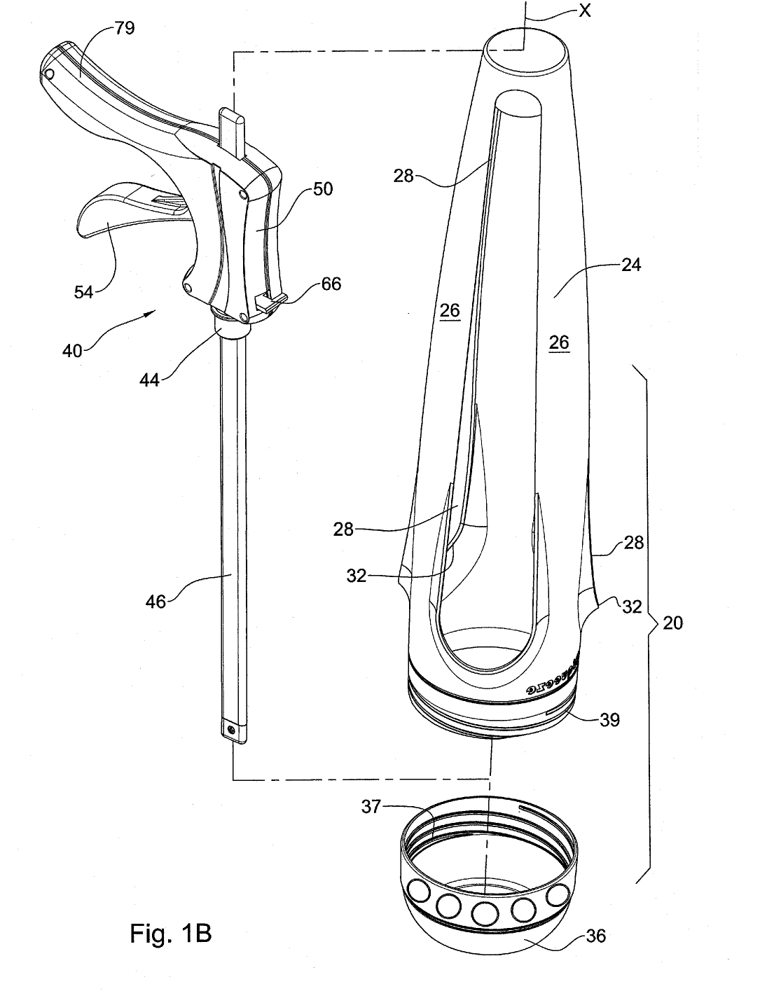

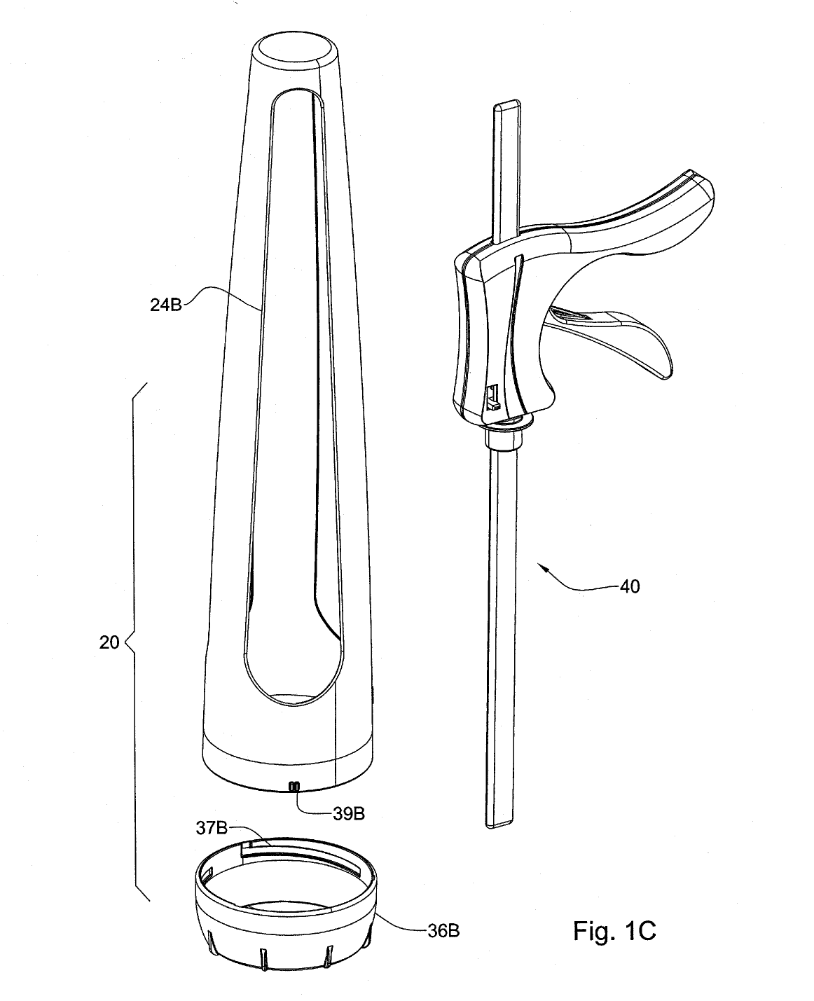

The bottom cover 36 is a removable cover. The cover can be securely attachable to the housing 24 by different arrangements. For example, and as best seen in FIG. 1B, it can be a full screw coupling wherein the bottom cover 36 is configured with an internal thread 37 adapted for screw coupling with the external threading 39 at the bottom opening of the housing 24. According to another example, as illustrated in FIG. 1C, the cover 36B is configured with a bayonet coupling recesses 37B configured for fast engagement with radial projections 39B externally configured at the bottom opening of the housing 24B, or a bayonet coupling as illustrated in FIG. 1C.

Removal of the cover 36, 36B exposes a bottle receiving space 30 configured for receiving the plastic-bottle 22 and securely receiving it therewithin. The height of the bottle makes no difference as the bottle-neck arresting plug 44 is axially displaceable and a compacting procedure as will be discussed hereinafter may take place at any start point along the longitudinal axis X. As far as diameter of the plastic container, this too does not play a significant role as long as the container fits within the bottle receiving space 30. However, it is appreciated that the neck arresting plug 44 is configured for receiving within the neck portion 48 of the container 22 such that the neck portion is prevented from wobbling about the longitudinal axis X upon downward axial displacement thereof, namely the neck portion 48 remains axially sturdy and will substantially perform only displacement about the longitudinal axis X.

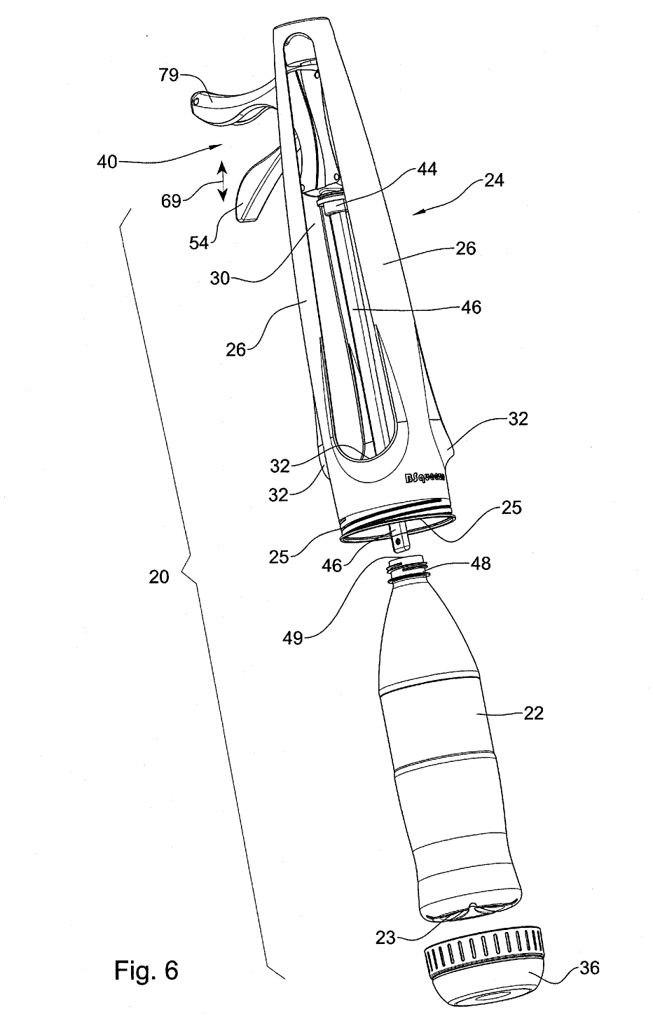

The displacing mechanism 40 is of the type often referred to as a caulking gun or silicon gun and comprise a displacing mechanism housing 50 made of rigid material and fitted at its lower end with the bottle-neck arresting plug 44 and slidingly mounted over the axial guiding member 46 which, as mentioned hereinabove, is a flat rod of material (such as metal, reinforced plastic material, etc.). The bottle-neck arresting plug 44 is sized for snugly receiving within the neck 48 of a bottle, through its opening 49 (FIG. 6). The length of the bottle-neck arresting plug 44 is such as to support a substantive length of the neck of the bottle 22, e.g. at least the threaded portions thereof.

The displacing mechanism 40 further comprises an operating handle 54, projecting laterally through one of the openings 28 formed at the housing, said handle which is pivotable about pivot 56 and is displaceable between a depressed position (FIG. 9) and its normally biased undepressed position as in the remaining figures by means of a spring mechanism (not shown). The displacing mechanism 40 may further be provided with a locking mechanism 58 to arrest the handle 54 in its depressed position of FIG. 9.

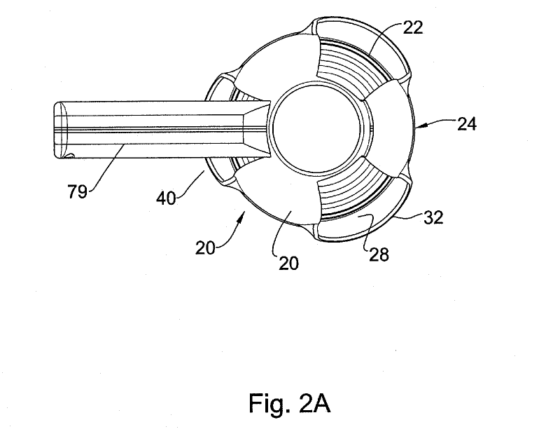

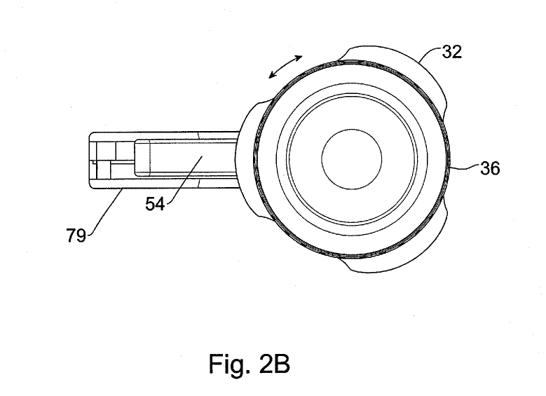

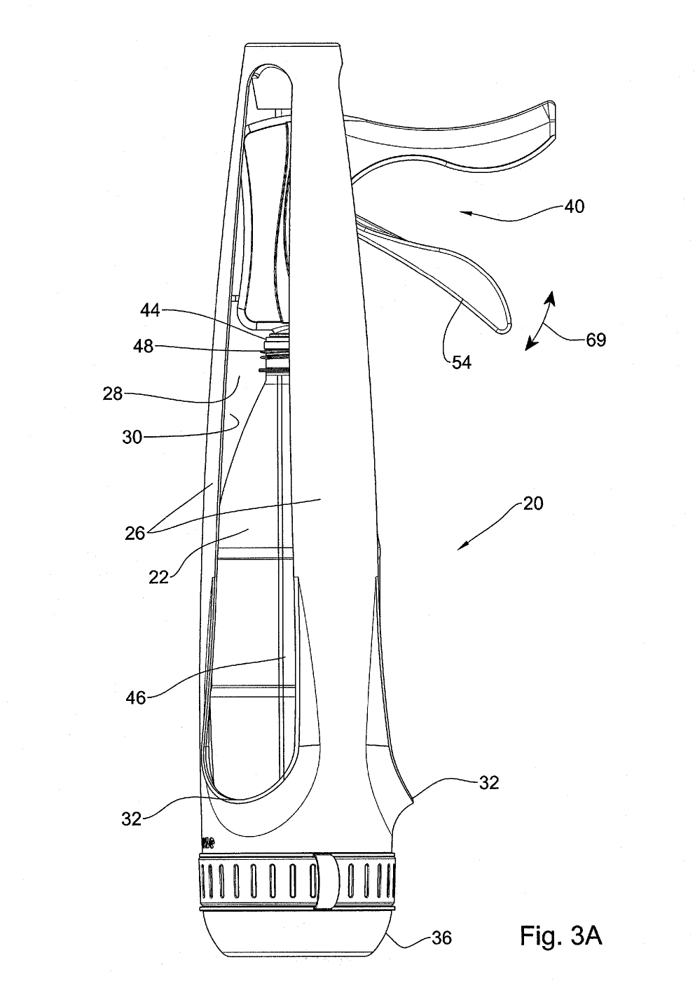

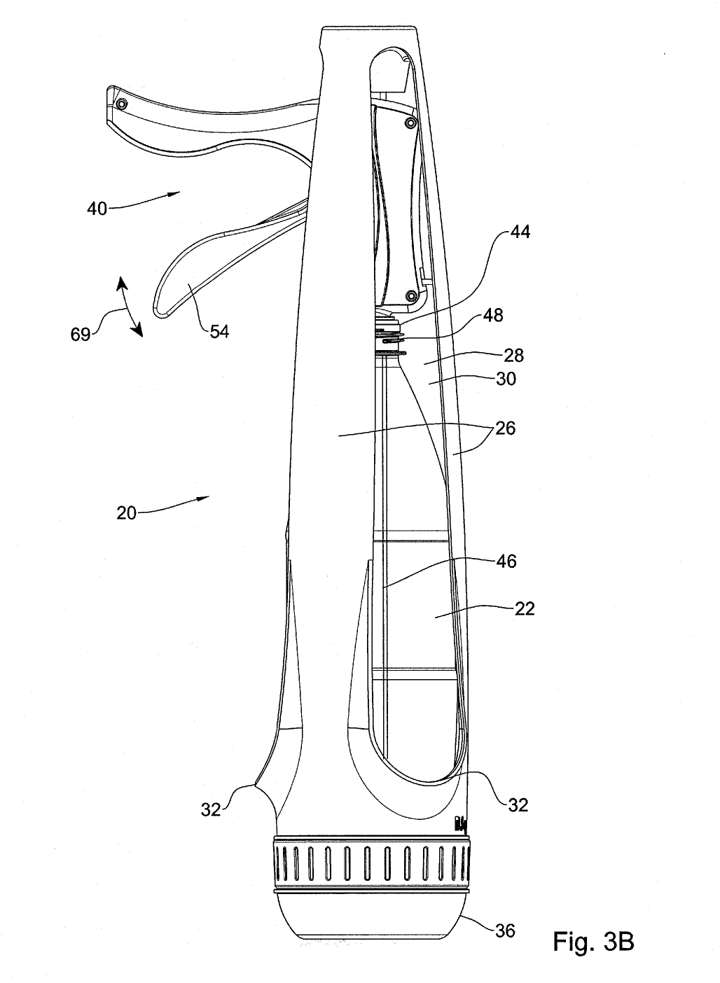

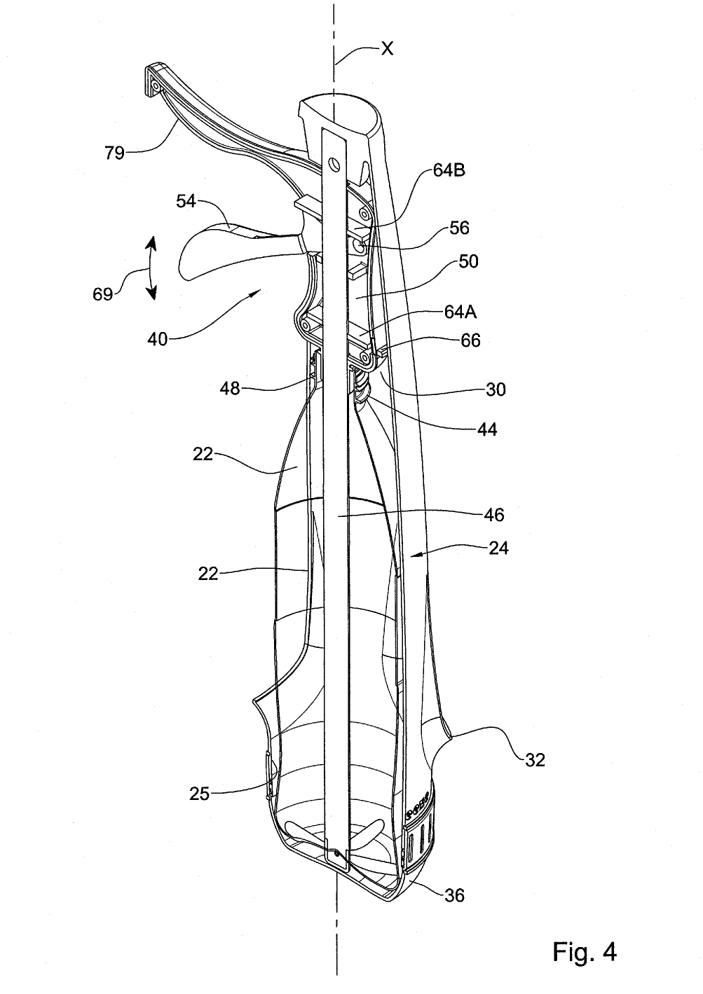

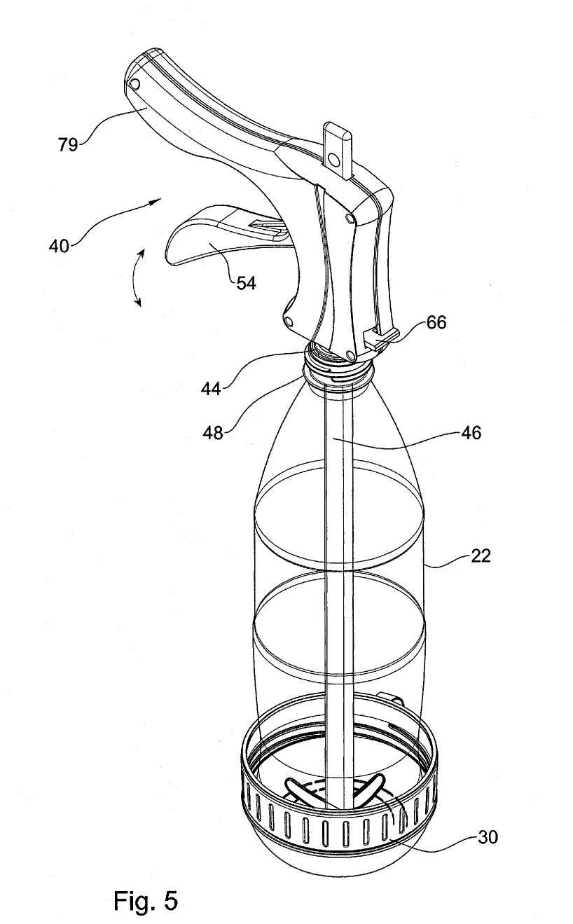

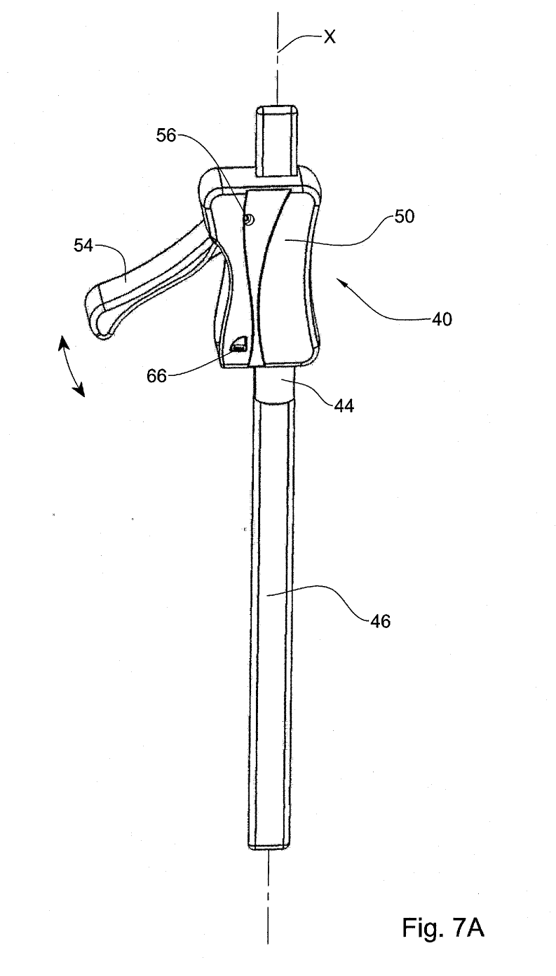

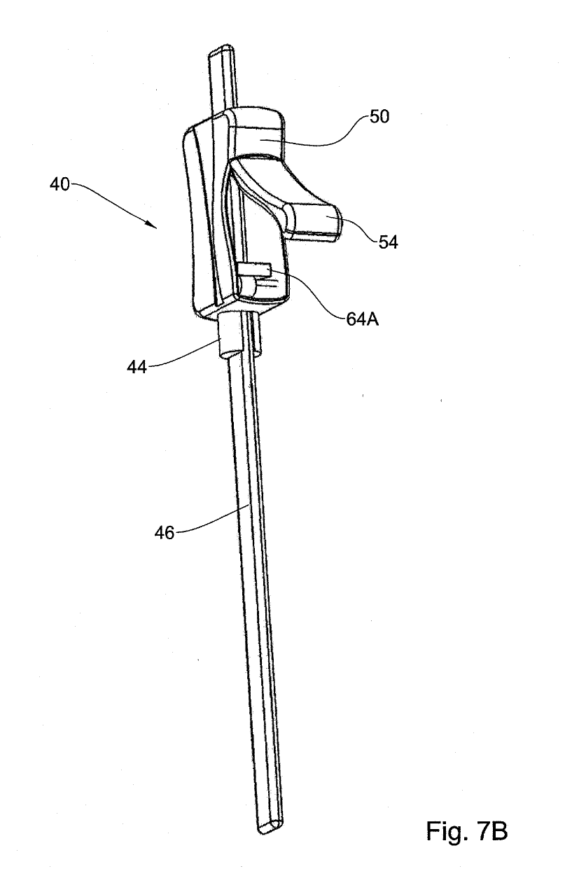

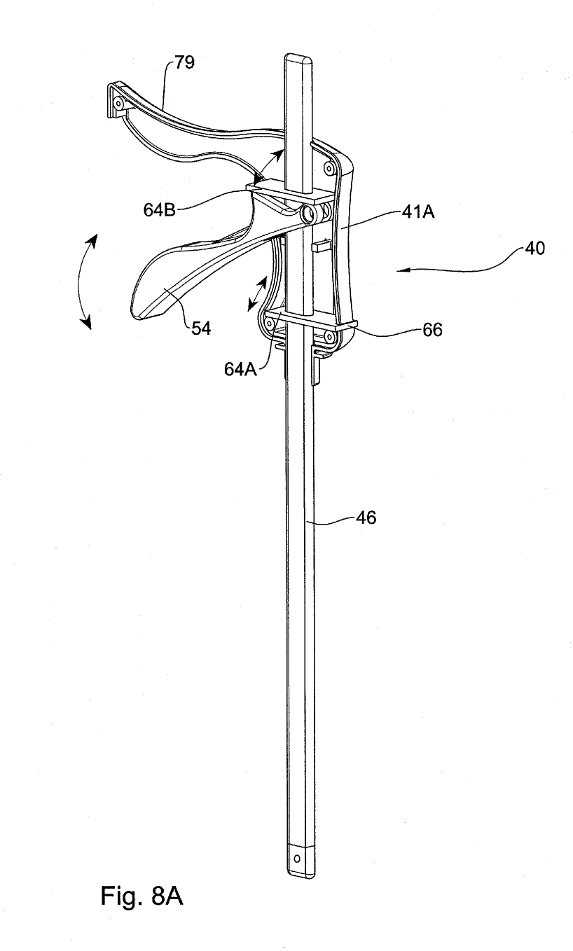

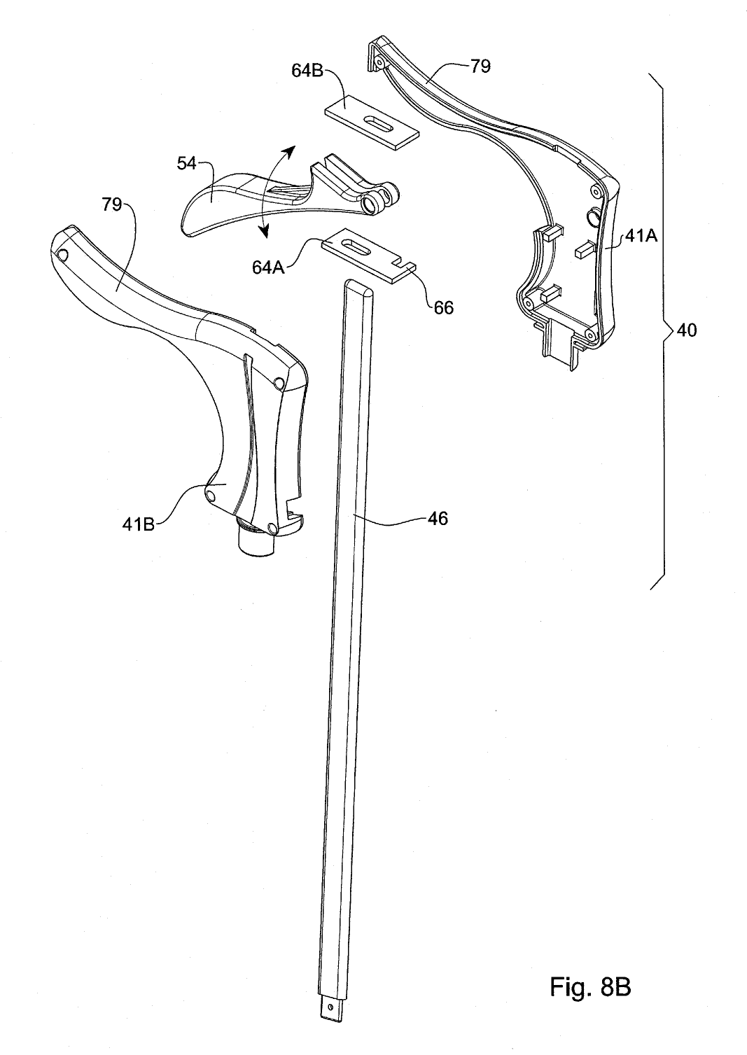

The displacing mechanism 40 may be of the mechanical ratchet-bar type mechanism, comprising one or two plate-shaped links 64A and 64B (best seen in FIGS. 8A and 8B) rocking over the rod 46 and facilitating axial displacement of the housing 50 only in one direction upon each depression of the handle 54. Displacement of the housing 50 in a reversed direction (namely upwards into the initial position of FIGS. 1 to 8 takes place by displacing the lower plate 64A by means of unlocking ratchet member 66 (FIG. 7A) thereby releasing the plate 64A and aligning it in substantial perpendicular orientation with respect to the rod 46, as known in such axial displacement mechanisms.

However, it is appreciated that rather than a smooth rod 46 and the mechanism illustrated in FIGS. 7A and 7B, there may be provided a toothed rod (FIG. 8) with an appropriate cog wheel rotatable within the housing whereby each depression of the handle 54 results in rotation of the cog wheel riding along the toothed rod, and further provided there is an arresting mechanism to prevent rotation of the wheel in a reversed direction, unless disconnected from the rod against the effect of a biasing spring member.

It should further be noted that the axial guiding member 46 may be removably secured at a top portion the housing, or fixedly secured at its top end within the housing.

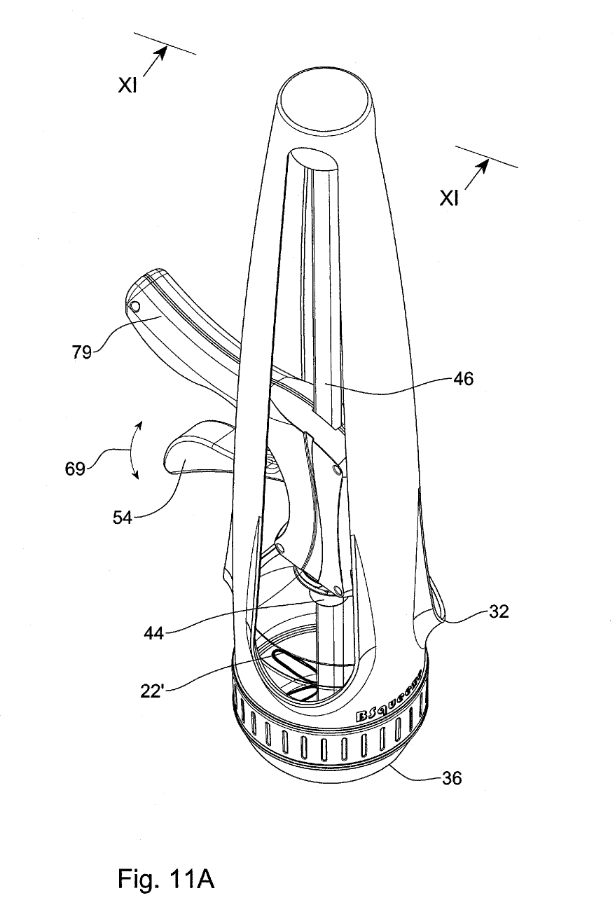

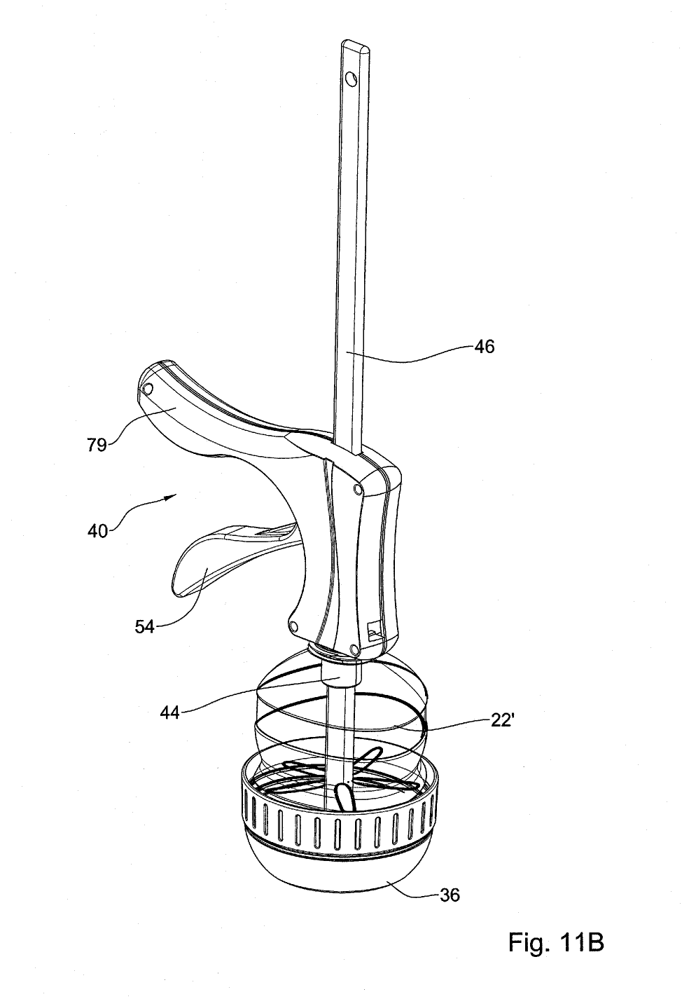

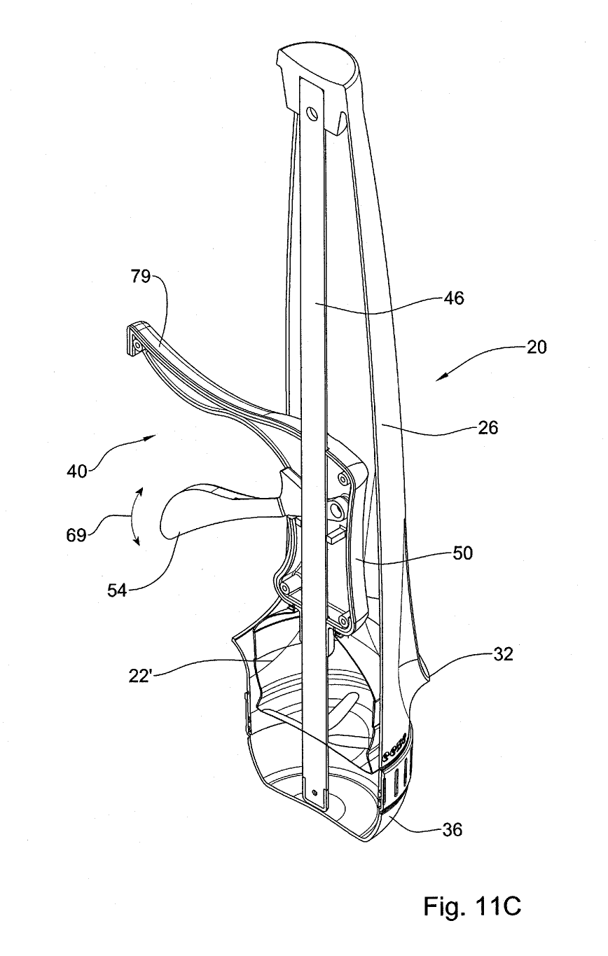

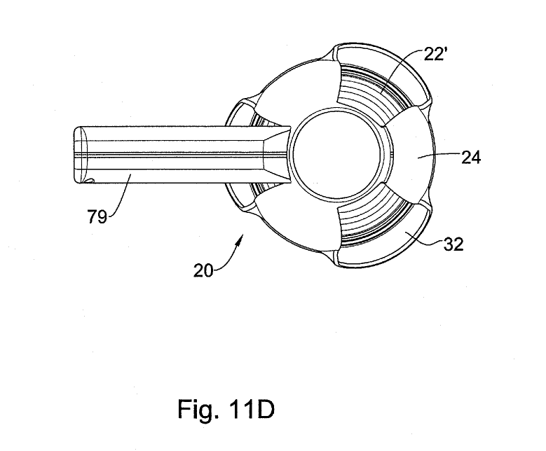

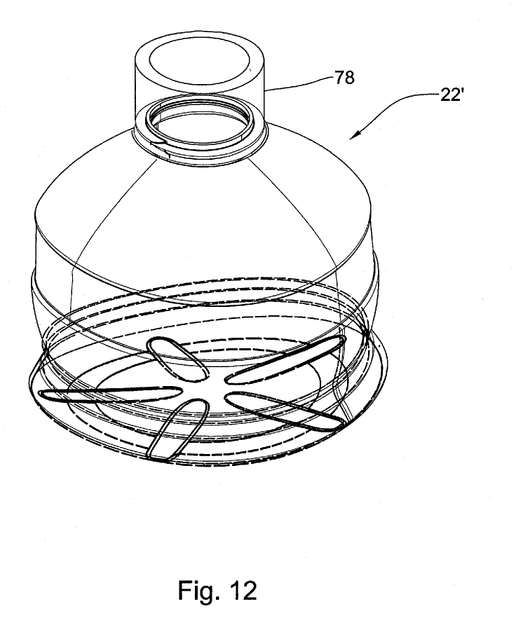

In use, the bottom cover 36 is removed from the housing 24 by unscrewing it, and the bottle is introduced into the housing and its neck 48 is securely fitted over the bottle-neck arresting plug 44 whereupon the bottom cover 36 is placed and secured against the housing. If the height of the bottle does not occupy the entire housing 24, then the displacing mechanism should be displaced downwards until a bottom 23 of the container 22 rests tight against the cover 36. Then, the handle 54 is repeatedly depressed in direction of arrow 69 (FIGS. 11), with the assistance of a gripping handle 79 whereby the displacing mechanism 40 creeps downwards along the axial guiding member 46, resulting in progressive compacting of the bottle 22 and shrinking it into the position of FIG. 12 designated 22′. The gripping handle 79 can be composed integrally with housing shells 41A and 41B (FIG. 8B), or integrated thereto.

It is noted that deformation of the bottle/container, as illustrated in FIG. 12, is plastic deformation, namely the container will not expend after the compression force applied by the displacing mechanism 40 has ended or upon removing the container from the devise.

The outwardly facing curved lips 32 serve as guides such that at the event that the cramped/deformed bottle portions project out through the openings 28, these portions are re-directed into the space 30 such that the compacted bottle 22′ can be easily removed from the housing 24.

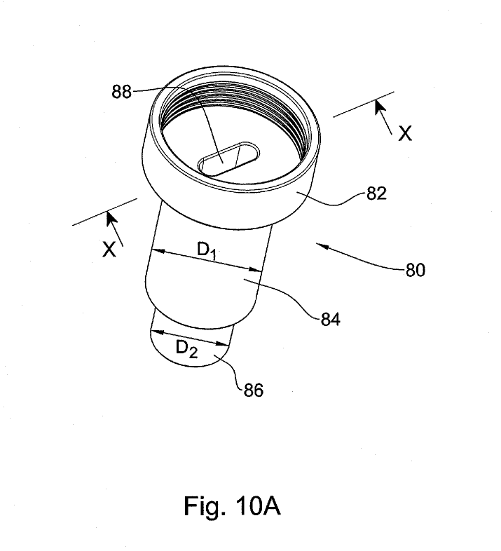

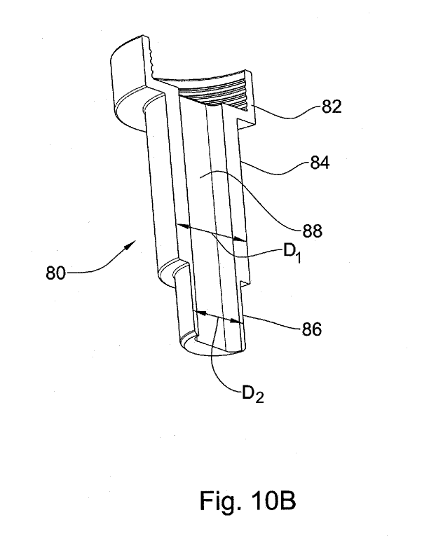

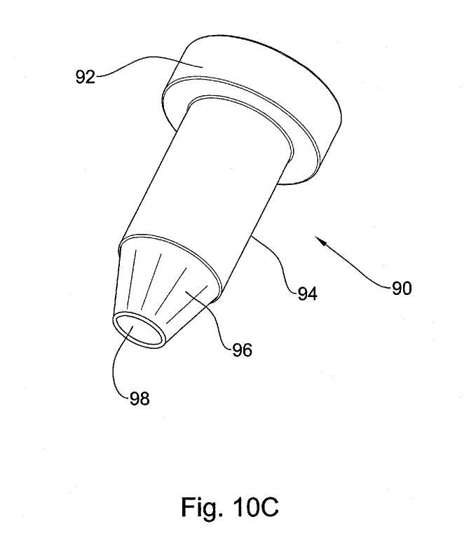

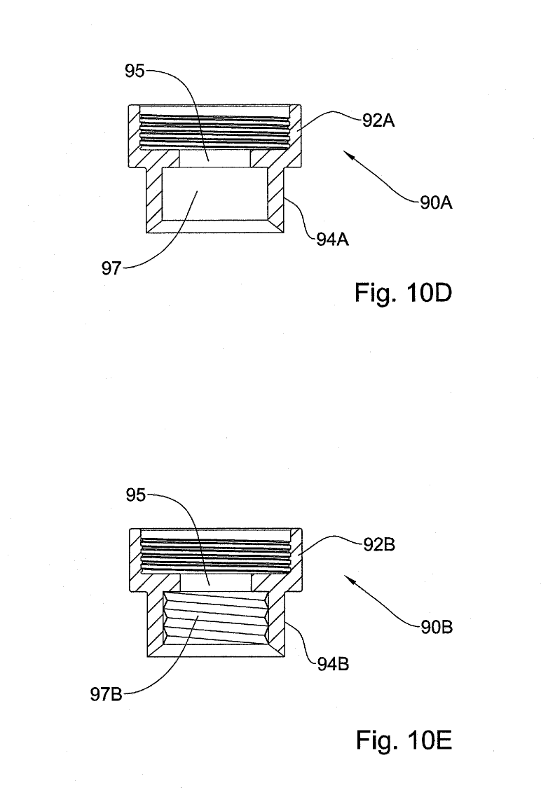

Turning now to FIGS. 10A to 10E there are illustrated different examples of bottle-neck arresting plugs. In FIGS. 10A and 10B the bottle-neck arresting plug 80 is comprises an internally threaded coupling portion 82 configured for coupling to a housing of the displacing mechanism configured for that purpose, i.e. fitted with a downwardly extending threaded extension (not shown) for coupling thereto the bottle-neck arresting plug 80. A through going groove 88 is noted in the bottle-neck arresting plug 80, configured for fit sliding displacement over the axial guiding member 46, with tolerances substantially eliminated therebetween.

The bottle-neck arresting plug 80 comprises a first cylindrical portion 84 coaxial with the coupling portion 82, and a second cylindrical portion 86, coaxial with the first cylindrical portion 84, and being of reduced diameter. The first cylindrical portion 84 is of a diameter D₁ suited for a first size of bottle-neck, whilst the second cylindrical portion 86 of a diameter D₂ is suited for a second, smaller size of bottle beck.

Turning now to FIG. 10C of the drawings there is illustrated a bottle-neck arresting plug 90 for use in a device according to the present disclosed subject matter, generally designated 90, and configured, similar to the example of FIGS. 10A and 10B, with an internally threaded coupling portion 92 configured for coupling to a housing of the displacing mechanism (not shown), a first cylindrical portion 94 coaxial with the coupling portion 92, and a leading portion 96 which tapers downwards from the first cylindrical portion 94. A through going groove 98 is also provided in the bottle-neck arresting plug 90, for fit sliding displacement over the axial guiding member 46, with tolerances substantially eliminated therebetween.

The tapering leading portion 96 is not configured for supporting the bottle-neck, but rather to facilitate easy mounting and positioned thereof over the first cylindrical portion 94, which serves for holding the bottle.

FIGS. 10D and 10E are directed to external bottle-neck arresting plugs. In FIG. 10D the bottle-neck arresting plug generally designated 90A is configured with an internally threaded coupling portion 92A configured for coupling to a housing of the displacing mechanism (not shown), with an opening 95 slidingly mounted over the axial guiding member 46, (not shown), and a cylindrical portion 94A configured with a bottle neck receptacle 97, sized for mounting over a bottle neck (i.e. the opening of a bottle, typically threaded but not restricted to a threaded bottle).

FIG. 10E is also directed to an external bottle-neck arresting plug generally designated 90B and is similar to that disclosed in connection with FIG. 10D, comprising an internally threaded coupling portion 92B configured for coupling to a housing of the displacing mechanism (not shown), with an opening 95 slidingly mounted over the axial guiding member 46, (not shown), and a cylindrical portion 94B configured with a bottle neck receptacle 97B, sized for mounting over a bottle neck (i.e. the opening of a bottle, typically threaded but not restricted to a threaded bottle, however wherein the neck receptacle 97B is threaded and configured for screw coupling to a bottle neck (not shown).

It is noted the bottle-neck arresting plugs according to any of the above examples comprise a tubular cylindrical portion, to thereby ensure that the bottle to be compacted is firmly supported while compression/compacting thereof, by preventing its wobbling with respect to the longitudinal axis of the device.

In FIG. 13 there is illustrated a modification of the bottle compacting device 100, differing from the previous examples in that rather than a compression handle the displacing mechanism generally designated 104 is configured with an electric motor. The housing 106 of the displacing mechanism accommodates a DC motor (not seen), a power source received within battery compartment 108 (e.g. a battery pack with regular/rechargeable one or more batteries) and an ON/OFF switch 110, activation of which results in traveling of the displacing mechanism 104 about the axial guiding member. An electric motor for displacing the bottle-neck arresting plug downwards may be also of the type comprising a toothed rod and a cog wheel, as discussed hereinabove.

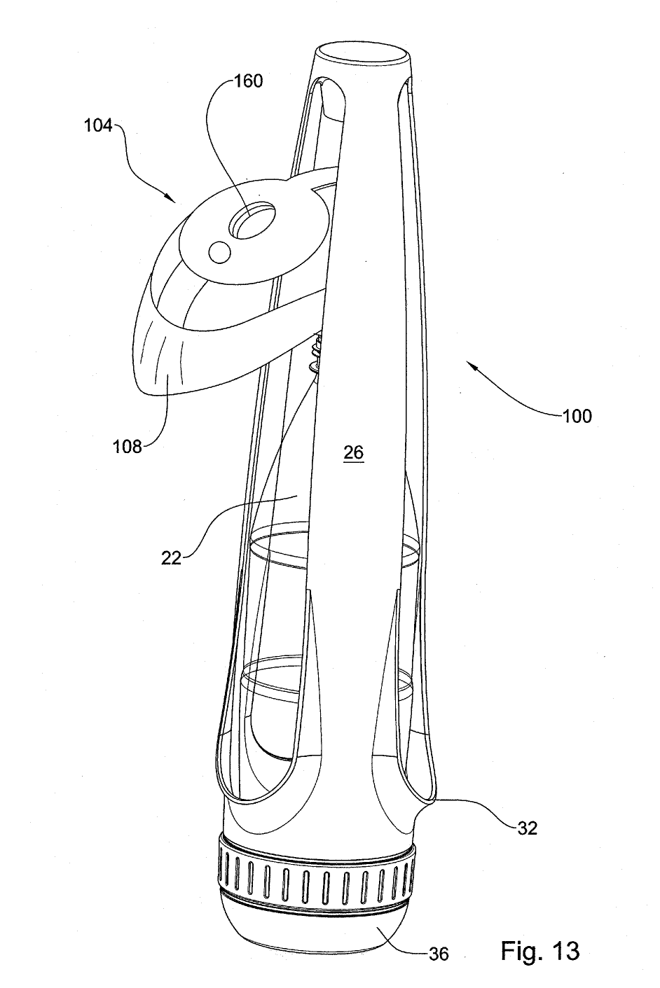

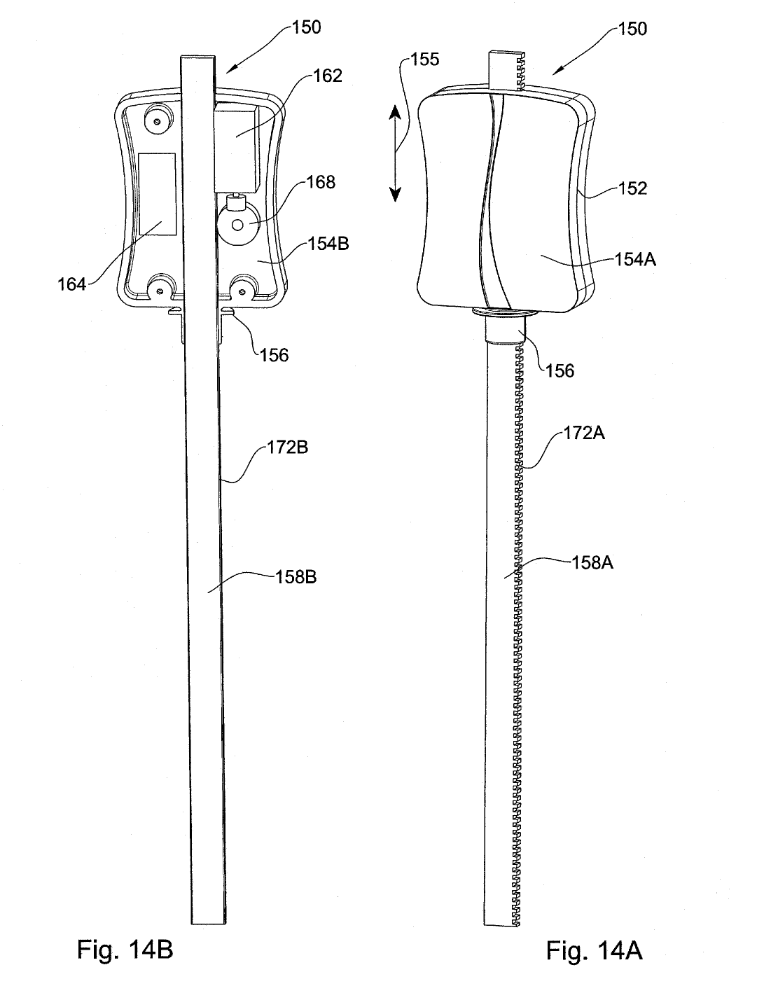

Turning now to FIGS. 14A and 14B there is illustrated an electric displacing mechanism generally designated 150 comprising a housing 152 composed of two shells 154A and 154B (shell 154A removed from FIG. 14B for sake of visualizing inside components of the mechanism), said housing configured with a bottle-neck arresting plug 156, and being axially displaceable over the axial guiding member 158 indirection of arrowed line 155. The housing 152 accommodates a DC motor 162 coupled to a battery 164 and articulated to a cog wheel 168 which is in turn engaged with a side wall of the axial guiding member 158. The electric circuitry further comprises an ON/OFF switch (not seen) and optionally a controller for stopping the DC motor once the housing has reached either its top/bottom end locations or upon some failure.

It is noted that in FIG. 14A the axial guiding member 158A is configured with a toothed side wall 172A whereby the cog engaged therewith (not seen) is typically a geared cog wheel. However, in FIG. 14B the axial guiding member 158B is configured with a smooth side wall 172B whereby the cog 168 engaged therewith is typically a friction-engaging cog wheel.

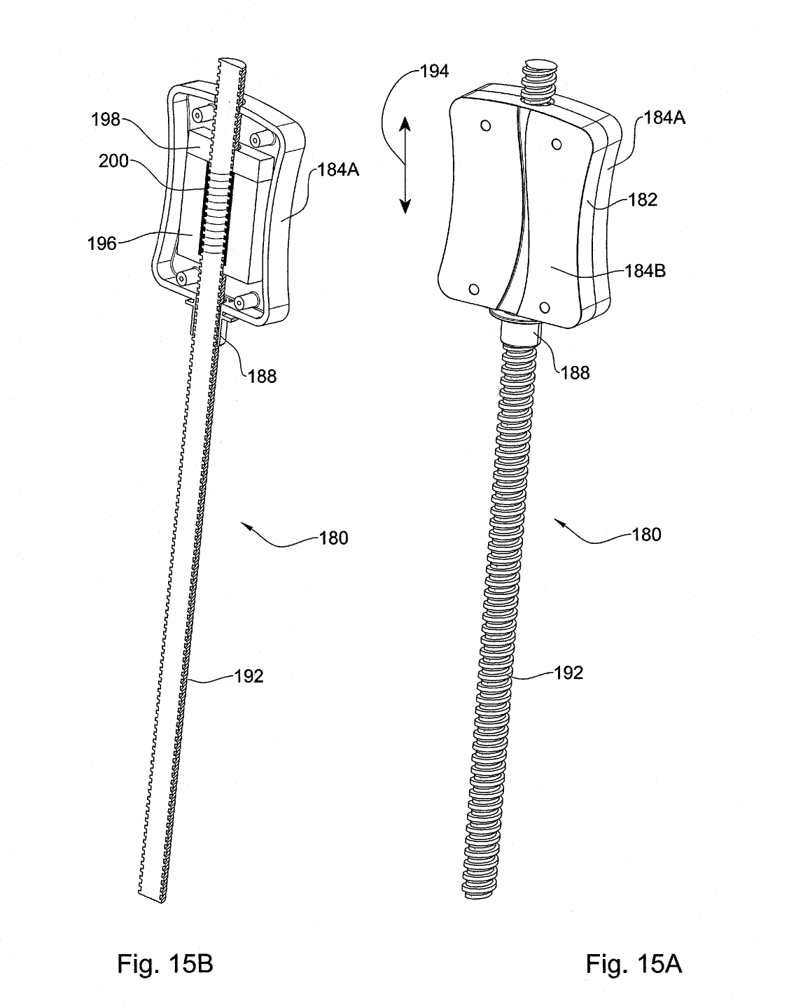

The example of FIGS. 15A and 15B illustrate an electric displacing mechanism generally designated 180 comprising a housing 182 composed of two shells 184A and 184B (shell 184B removed from FIG. 15B for sake of visualizing inside components of the mechanism), said housing configured with a bottle-neck arresting plug 188, and being axially displaceable over the axial guiding member 192 in direction of arrowed line 194. It is noted that the axial guiding member 192 is a threaded rod. The housing 182 accommodates a DC motor 196 coupled to a battery 198, said motor configured with an integrated worm gear wheel 200 which is in turn engaged with the axial guiding member 192. The electric circuitry further comprises an ON/OFF switch (not seen) and optionally a controller for stopping the DC motor once the housing has reached either its top/bottom end locations or upon some failure. The housing 182 is mountable within the housing of the compacting device (not shown) in a fashion preventing rotation of the housing 182, whereby activating the motor 196 results in rotating the worm gear wheel 200 whereby the axial guiding member 192 is imparted rotary motion such that it axially displaces in direction of arrowed line 194, resulting in that the neck arresting plug 188 is axially displaced between an initial bottle loading position (a top position), towards the opening at a compacting position (a bottom position), and is displaced axially back to its initial position so as to receive an intact, uncompressed bottle.

FIGS. 16A and 16B are directed to examples of bottom covers. In FIG. 16A the cover 206 is configured for engagement with the housing of the compactor (not shown) by a bayonet arrangement 208, as in the example of FIG. 1C, and however there is provided an adapting ring 210 for supporting a bottle of smaller size than the nominal size of the compactor. The adapting ring 210 can be fixed within the cover 206, wherein several covers can be provided for supporting different bottle sizes, or the adapting ring 210 can be replaceable.

In FIG. 16B the cover 220 is also a bayonet type coupler 222, and however the adapting ring 226 has a tapering cross-section so that bottles of different sizes can be used with a single cover.

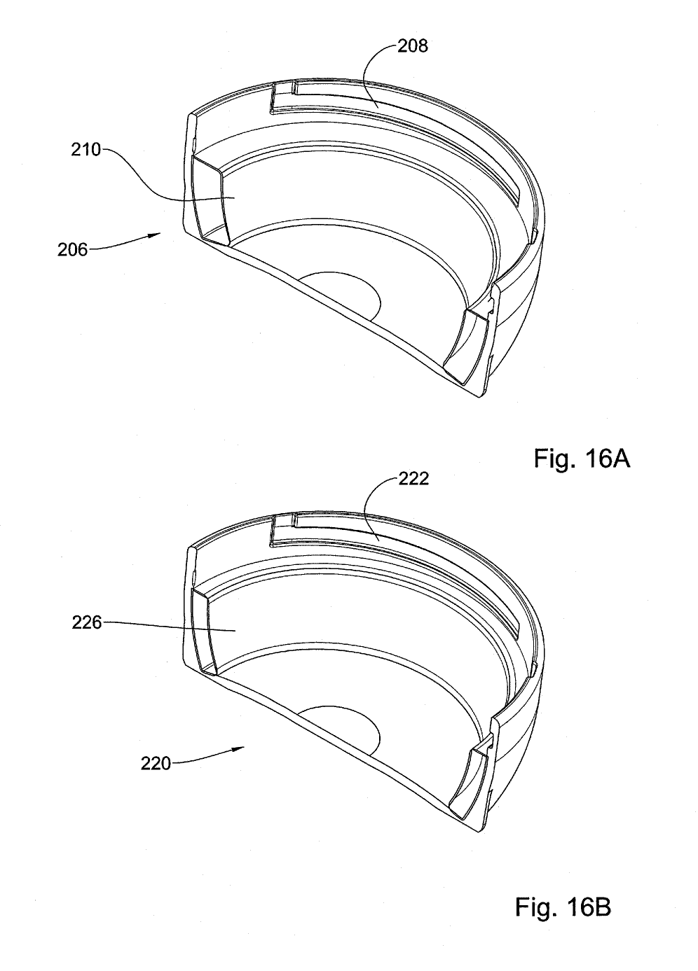

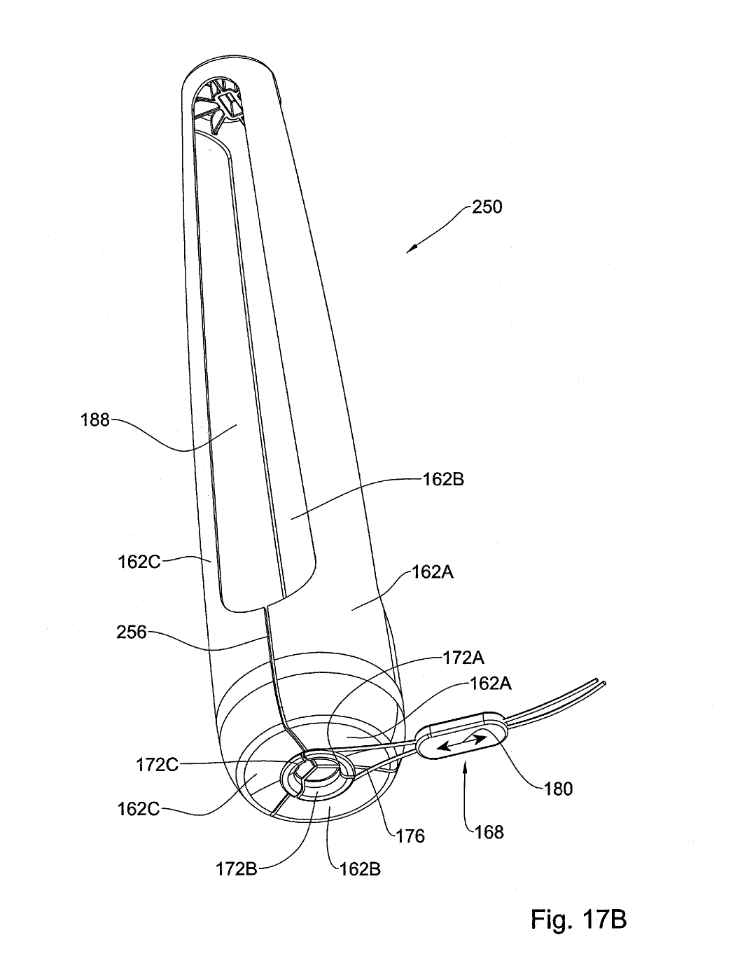

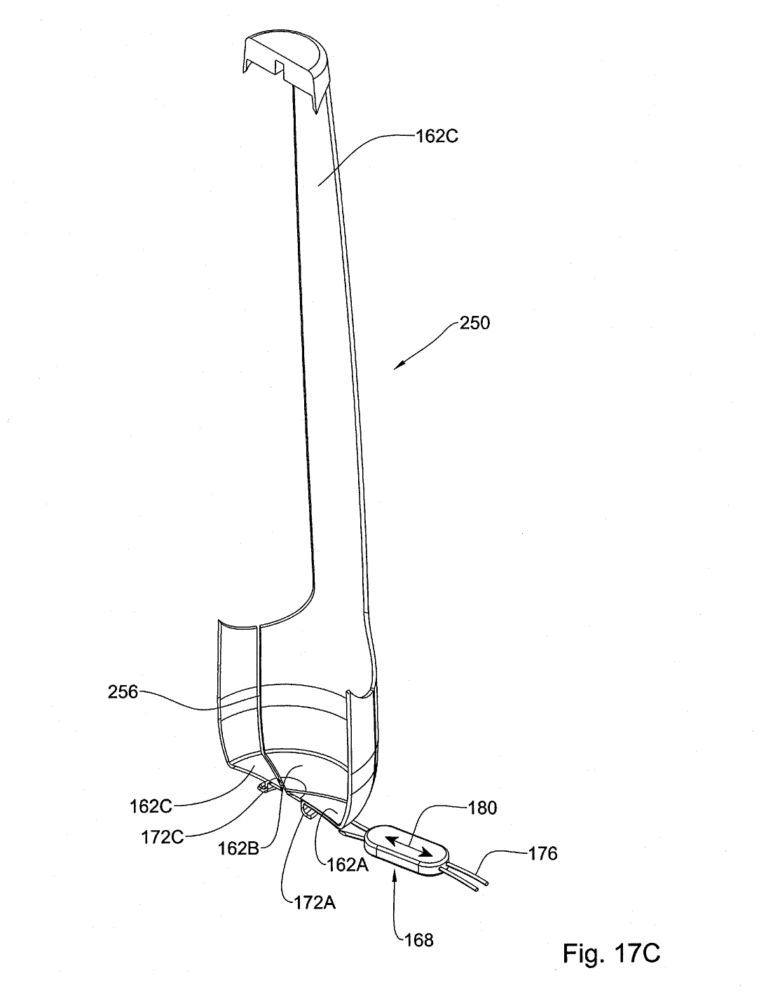

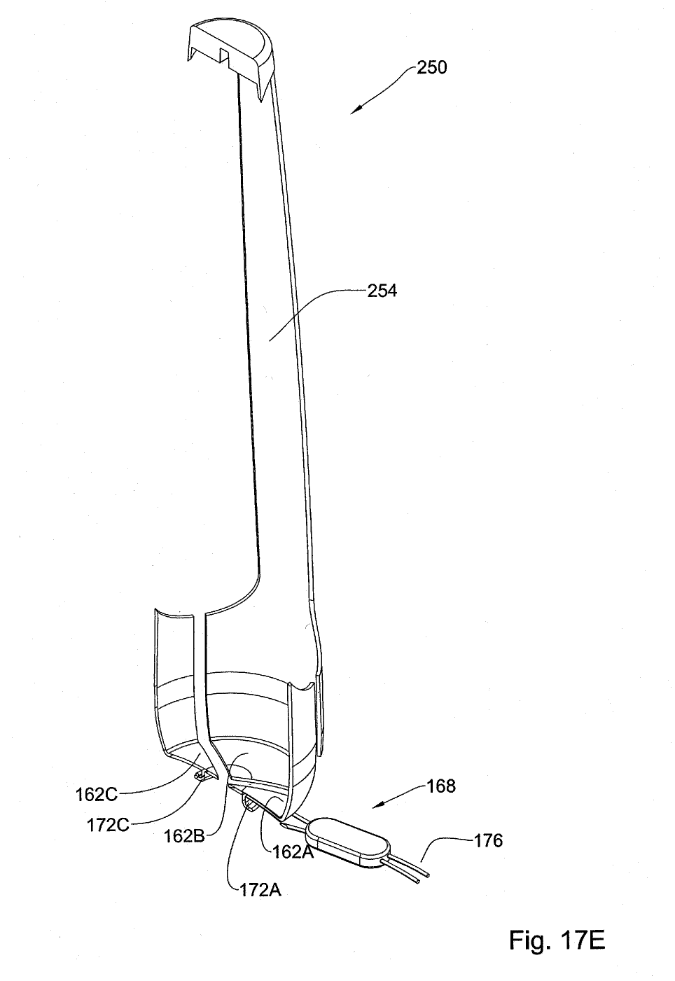

Turning now to FIGS. 17A to 17E, there is illustrated yet a configuration of a bottle compactor according to the presently disclosed subject matter. The representations illustrate only the housing, and the displacing mechanism is not shown. The housing is configured with longitudinal recess 252 extending from each of the longitudinally extending apertures 254. said recesses 252 extending down to a bottom end of the housing (seen as 256). It is seen that the cover portion 258 is integrated with the side walls of the housing and that the recesses 252 and 256 actually coextend through the cover portion 258, imparting the housing a segmented configuration, which in the present example comprises three segments 162A, 162B and 162C The material of the housing Is rigid, e.g. metal, however having a sufficient degree of elasticity such that the segments are radially displaceable between a contracted position (FIGS. 17A, 17B and 17C) and an expanded position (FIGS. 17D and 17E).

A bottom opening closing mechanism is provided, which in the present example is a cord retention device 168, wherein the bottom of the three segments 162A, 162B and 162C is configured with respective segmented cord arresting guides 172A, 172B and 172C, respectively. A cord 176 is looped over the cord arresting guides 172A, 172B and 172C and extends into the cord retention device 168. The arrangement is such that the cord retention device 168 is displaceable over the cord ends in direction of arrowed line 180, whereby by loosening the cord 176 facilitates radial expansion of the three segments 162A, 162B and 162C (FIGS. 17D and 17E) allowing to introduce a bottle of larger diameter into the bottle receiving space 188, and tensioning the cord (FIGS. 17A, 17B and 17C) results in contraction of the three segments 162A, 162B and 162C into a restricted size.

It is appreciated that rather than the cord retention device illustrated above, there can be configured different mechanism for retaining the segments at their position and withstanding radial and axial forces applied during a bottle compacting process. Such mechanism can be, for example, a ratchet mechanism, an electric winding motor, a fastener band and the The bottle compactor according to the present disclosure can be used for of compacting bottles made of a variety of plastic or carton materials. One particular example is the commonly used beverage bottles, often made of PET (polyethylene terephthalate) which is a popular package for food and non-food products, having qualities rendering it sufficiently strong, thermally-stable and transparent, inexpensive, lightweight, resealable, shatter-resistant and recyclable.

While there has been shown a preferred embodiment of the invention, it is to be understood that many changes may be made therein without departing from the spirit of the invention, Mutatis Mutandis. For example, the roll over valve function may be achieved by other valve types.

1. A bottle compactor, comprising:
a housing configured with side walls defining a bottle receiving space and sized for receiving therein a bottle;
an opening for axially introducing the bottle;
a bottle-neck arresting plug configured for supporting a top end portion of the bottle; and
a displacing mechanism configured for axially displacing said bottle-neck gripping plug along an axial guide member, between a bottle receiving position and a compacted position, and an opening cover for supporting the bottle as it is being compacted.

2. The bottle compactor according to claim 1, wherein the housing has a cross-section corresponding with that of the bottle.

3. The bottle compactor according to claim 1, wherein the housing is configured with a bottle receiving space constituted by an inside surface of sidewalls of the housing, wherein at least a bottom portion of said side walls takes part in determining the final shape of a compacted bottle.

4. The bottle compactor according to claim 1, wherein sidewalls of the housing are configured with longitudinally extending openings.

5. The bottle compactor according to claim 4, wherein the longitudinally extending openings are configured with outwardly facing curved lips serving as guides such that at the event that cramped bottle portions project out through the openings these portions are re-directed into the bottle receiving space.

6. The bottle compactor according to claim 1, wherein the bottle-neck arresting plug is configured for arresting engagement with a diversity of top neck portions of bottles, at an internal configuration or at an external configuration.

7. The bottle compactor according to claim 1, wherein the guide member extends through a major length of the bottle receiving space.

8. The bottle compactor according to claim 1, wherein the displacing mechanism is configured with a force amplifying mechanism, such that it requires substantially little force for displacing the neck arresting plug between the bottle receiving position and the compacted position.

9. The bottle compactor according to claim 1, wherein the displacing mechanism a is a mechanical ratchet-bar type mechanism comprises an operating handle for manual manipulation of the displacing mechanism, said operating handle radially projects through a longitudinal opening formed along the housing.

10. The bottle compactor according to claim 1, wherein an adapting member is configured for securing to the opening cover, or integrated therewith, for supporting bottles of different diameters and bottles of non-cylindrical shapes.

11. The bottle compactor according to claim 10, wherein the adapting member can extend substantially the entire length of the bottle receiving space, or at least at a bottom portion thereof.

12. The bottle compactor according to claim 1, wherein the diameter of the bottle receiving space is configurable to accommodate bottles of different diameters, by applying the housing with one or more longitudinal recesses extending from the bottom opening and upwards, with the provision of a radius adapting mechanism configured for retaining the housing at any determined radial expansion state.

13. The bottle compactor according to claim 1, wherein the axial guide member is secured at a top end thereof within a top end of the housing.
